(19) United States
(12) Patent Application Publication
(10) Pub. No.: US 2026/0235244 A1
(43) Pub. Date: Aug. 13, 2026

(54) PIPE COUPLING

(71) Applicant: NITTA CORPORATION, Osaka-shi, Osaka (JP)

(72) Inventors: Yasunori KUSU, Nabari-shi, Mie (JP); Mizuho HITOTSUBASHI, Osaka-shi, Osaka (JP)

(21) Appl. No.: 19/156,785

(22) PCT Filed: Oct. 27, 2023
(86) PCT No.: PCT/JP2023/038883

§ 371 Date: Aug. 14, 2025

(30) Foreign Application Priority Data
Feb. 17, 2023 (JP) 2023-023819

(51) Int. Cl. F16L 37/56; F16L 37/098

(52) U.S. Cl. CPC F16L 37/56; F16L 37/098

(57) ABSTRACT

A male member of a pipe coupling includes a plurality of tube couplings held by a retainer and to which tubes are attachable, the retainer includes a plurality of receiving portions into which the tube couplings are fitted, a linking portion that links the plurality of receiving portions, and a rod-shaped portion extending from the linking portion at an angle such that a diameter expands with respect to an axis of the male member. The rod-shaped portion engages with a wall surface of the female member in a state in which the male member is inserted into a female member of the pipe coupling to prevent the female member and the male member from coming off. Further, when the rod-shaped portion is pressed, the rod-shaped portion is elastically deformed with a base end thereof as a fixed end to release the engagement with the wall surface of the female member.

### TECHNICAL FIELD

The present invention relates to a pipe coupling.

### BACKGROUND ART

A pipe coupling is used for pipes for fluid such as compressed air, gas, and liquid. Patent Literature 1 discloses a pipe coupling in which an appropriate tube connection state is obtained.

In the pipe coupling disclosed in Patent Literature 1, a male member includes a tube coupling, and a female member and the male member are in a fluid-tight state when the female member and the male member are connected to each other. The female member is provided with engaging portions on a constituent wall surface, and the male member is provided with rod-shaped portions extending from an annular portion at an angle such that a diameter expands with respect to an axis of the male member. An engaging claw is disposed in a substantially central portion in a length direction of each of the rod-shaped portions, and an operation portion is formed on a free end side of each of the rod-shaped portions. The female member and the male member are prevented from coming off by the engagement between the engaging claws and the engaging portions, and when the operation portions are pressed inward, the rod-shaped portions are elastically deformed with attachment ends thereof as fixed ends, so that the engaging claws and the engaging portions are in a disengaged state.

### CITATION LIST

### Patent Literature

Patent Literature 1: JP2008-008435A

### SUMMARY OF INVENTION

### Technical Problem

In the pipe coupling disclosed in Patent Literature 1, in order to connect a plurality of tubes to the female member, it is necessary to insert the male members into the female member according to the number of tubes, and the number of work hours is very large. In addition, a work space around the pipe coupling tends to be reduced along with the miniaturization and space-saving of devices in which the pipe coupling is mounted.

An object of the present invention is to provide a pipe coupling capable of reducing the number of work hours and improving workability in a narrow work space in a tube connection work.

### Solution to Problem

The present invention is a pipe coupling including: a female member; and a male member to be inserted into the female member, in which the male member includes a plurality of tube couplings to which tubes are attachable, and a retainer that holds the plurality of tube couplings, the retainer includes a plurality of receiving portions into which the tube couplings are fitted, a linking portion that links the plurality of receiving portions, and a rod-shaped portion extending from the linking portion at an angle such that a diameter expands with respect to an axis of the male member, and the rod-shaped portion engages with a wall surface of the female member in a state in which the male member is inserted into the female member to prevent the female member and the male member from coming off, and when the rod-shaped portion is pressed, the rod-shaped portion is elastically deformed with a base end thereof as a fixed end to release the engagement with the wall surface of the female member.

### Advantageous Effects of Invention

According to the present invention, the male member includes the retainer that holds the plurality of tube couplings. Therefore, the plurality of tubes are connected to the female member only by inserting one male member into the female member. In addition, the plurality of tube couplings are held by one retainer, whereby external dimensions of the male member can be reduced. Therefore, it is possible to provide the pipe coupling capable of reducing the number of work hours and improving workability in a narrow work space in a tube connection work.

### BRIEF DESCRIPTION OF DRAWINGS

FIG. 1A is a perspective view of a pipe coupling according to a first embodiment, illustrating a state before a female member and male members are connected.

FIG. 1B is a perspective view of the pipe coupling according to the first embodiment, illustrating a state in which the female member and the male members are connected.

FIG. 2A is a front view of the pipe coupling according to the first embodiment, illustrating the state before the female member and the male member are connected.

FIG. 2B is a top view of the pipe coupling according to the first embodiment, illustrating the state before the female member and the male member are connected.

FIG. 2C is a front view of the pipe coupling according to the first embodiment, illustrating the state in which the female member and the male member are connected.

FIG. 2D is a top view of the pipe coupling according to the first embodiment, illustrating the state in which the female member and the male member are connected.

FIG. 3A is a cross-sectional view taken along line IIIA-IIIA illustrated in FIG. 2B.

FIG. 3B is a cross-sectional view taken along line IIIB-IIIB illustrated in FIG. 2A.

FIG. 3C is a cross-sectional view taken along line IIIC-IIIC illustrated in FIG. 2D.

FIG. 3D is a cross-sectional view taken along line IIID-IIID illustrated in FIG. 2C.

FIG. 4 is a perspective view of the male member illustrated in FIG. 1A, illustrating a state in which tube couplings are removed from a retainer.

FIG. 5 is a cross-sectional view taken along line V-V illustrated in FIG. 2A.

FIG. 6A is a side view of the male member illustrated in FIG. 2A as viewed in a direction of an arrow VIA.

FIG. 6B is a side view of the female member illustrated in FIG. 2A as viewed in a direction of an arrow VIB.

FIG. 6C is a cross-sectional view taken along line VIC-VIC illustrated in FIG. 2C.

FIG. 7A is a perspective view of a pipe coupling according to a second embodiment, illustrating a state before a female member and male members are connected.

FIG. 7B is a perspective view of the pipe coupling according to the second embodiment, illustrating a state in which the female member and the male members are connected.

FIG. 8A is a front view of the pipe coupling according to the second embodiment, illustrating the state before the female member and the male member are connected.

FIG. 8B is a top view of the pipe coupling according to the second embodiment, illustrating the state before the female member and the male member are connected.

FIG. 8C is a front view of the pipe coupling according to the second embodiment, illustrating the state in which the female member and the male member are connected.

FIG. 8D is a top view of the pipe coupling according to the second embodiment, illustrating the state in which the female member and the male member are connected.

FIG. 9A is a cross-sectional view taken along line IXA-IXA illustrated in FIG. 8B.

FIG. 9B is a cross-sectional view taken along line IXB-IXB illustrated in FIG. 8A.

FIG. 9C is a cross-sectional view taken along line IXC-IXC illustrated in FIG. 8D.

FIG. 9D is a cross-sectional view taken along line IXD-IXD illustrated in FIG. 8C.

FIG. 10 is a perspective view of the male member illustrated in FIG. 7A, illustrating a state in which tube couplings are removed from a retainer.

FIG. 11 is a cross-sectional view taken along line XI-XI illustrated in FIG. 8A.

FIG. 12A is a side view of the male member illustrated in FIG. 8A as viewed in a direction of an arrow XIIA.

FIG. 12B is a side view of the female member illustrated in FIG. 8A as viewed in a direction of an arrow XIIB.

FIG. 12C is a cross-sectional view taken along line XIIC-XIIC illustrated in FIG. 8C.

### DESCRIPTION OF EMBODIMENTS

Hereinafter, embodiments of the present invention will be described in detail with reference to the drawings. Each embodiment to be described below is an example of the present invention, and the present invention is not limited thereto. In the following description of the embodiments, the same components are denoted by the same reference numerals, and the description thereof will be appropriately omitted.

### First Embodiment

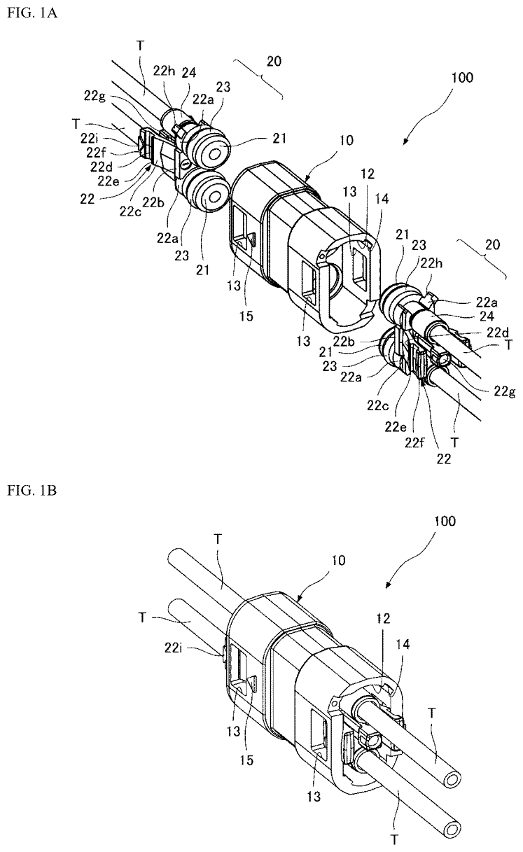

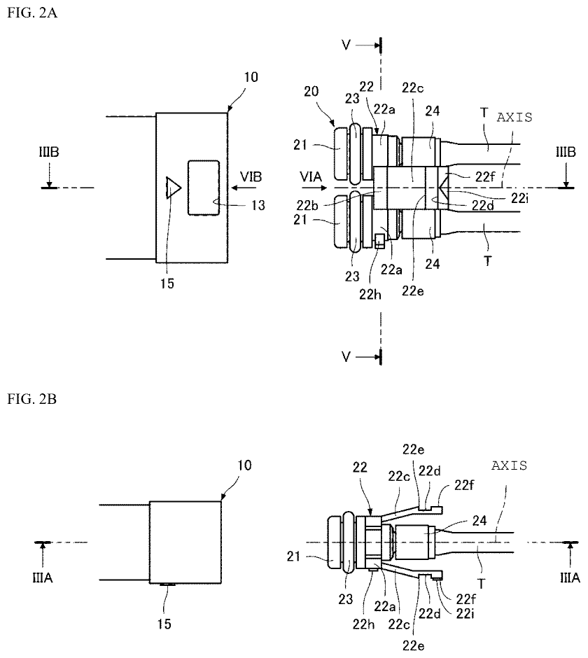

FIG. 1A is a perspective view of a pipe coupling 100 according to a first embodiment, illustrating a state before a female member 10 and male members 20 are connected. FIG. 1B is a perspective view of the pipe coupling 100 according to the first embodiment, illustrating a state in which the female member 10 and the male members 20 are connected. FIG. 2A is a front view of the pipe coupling 100 according to the first embodiment, illustrating the state before the female member 10 and the male member 20 are connected. FIG. 2B is a top view of the pipe coupling 100 according to the first embodiment, illustrating the state before the female member 10 and the male member 20 are connected. FIG. 2C is a front view of the pipe coupling 100 according to the first embodiment, illustrating the state in which the female member 10 and the male member 20 are connected. FIG. 2D is a top view of the pipe coupling 100 according to the first embodiment, illustrating the state in which the female member 10 and the male member 20 are connected.

As illustrated in FIGS. 1A to 2D, the pipe coupling 100 includes the female member 10 and the male members 20 to be inserted into the female member 10. When the male members 20 are inserted into the female member 10 and connected to the female member 10, the male members 20 and the female member 10 are in a fluid-tight state. FIGS. 1A and 1B illustrate an example in which two male members 20 are inserted into one female member 10 from both sides, but the present invention is not limited to this form, and for example, one male member 20 may be inserted into one side of the female member 10. In addition, the female member 10 may be bent by 90 degrees, or a shape of an insertion portion of the female member 10 may be directly processed into a pneumatic device or the like.

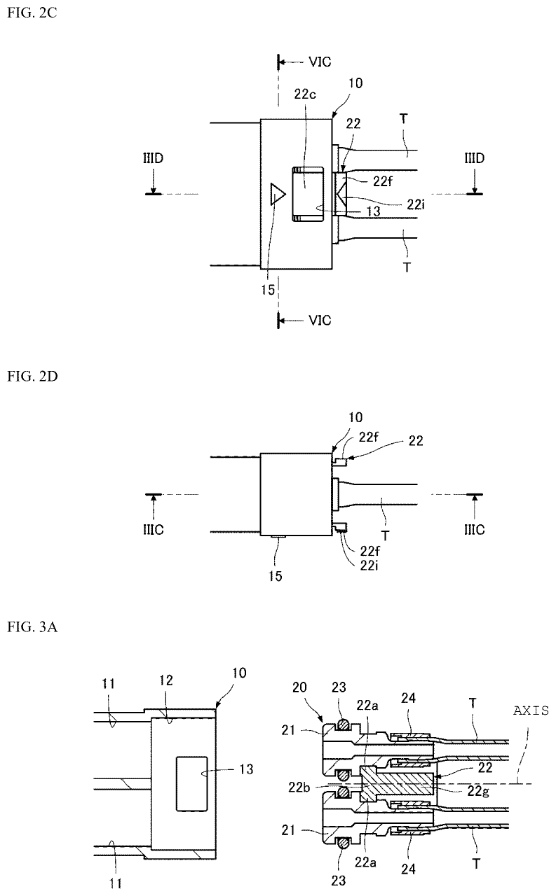

FIG. 3A is a cross-sectional view taken along line IIIA-IIIA illustrated in FIG. 2B. FIG. 3B is a cross-sectional view taken along line IIIB-IIIB illustrated in FIG. 2A. FIG. 3C is a cross-sectional view taken along line IIIC-IIIC illustrated in FIG. 2D. FIG. 3D is a cross-sectional view taken along line IIID-IIID illustrated in FIG. 2C.

As illustrated in FIGS. 3A and 3C, the female member 10 has two small-diameter hole portions 11 and a common hole portion 12 continuous with the two small-diameter hole portions 11. Central axes of the two small-diameter hole portions 11 are substantially parallel to an insertion direction of the male member 20. Engaging holes 13 are formed in a wall surface of the common hole portion 12.

The male member 20 includes two tube couplings 21 to which tubes T can be attached, and a retainer 22 that holds the two tube couplings 21. FIGS. 1A to 3D illustrate a state in which the tubes T are properly attached to the respective tube couplings 21.

Central axes of the two tube couplings 21 are substantially parallel to each other, and an interval between the central axes of the two tube couplings 21 is substantially equal to an interval between the two small-diameter hole portions 11 of the female member 10. By moving the male member 20 to the female member 10 along the central axes of the tube couplings 21, the tube couplings 21 are inserted into the small-diameter hole portions 11 of the female member 10.

Each of the tube couplings 21 is provided with a seal ring 23 on an outer periphery thereof. As illustrated in FIG. 3C, in a state in which the tube couplings 21 are inserted into the small-diameter hole portions 11 of the female member 10, the seal ring 23 seals between an outer peripheral surface of the tube coupling 21 and an inner peripheral surface of the small-diameter hole portion 11. The seal rings 23 ensure fluid tightness between the male member 20 and the female member 10.

In the present embodiment, an axis extending parallel to the insertion direction of the male member 20 between the two tube couplings 21 is referred to as an “axis of the male member 20”. In addition, a direction in which the tube couplings 21 are inserted into the small-diameter hole portions 11 of the female member 10 is referred to as a “forward direction”, and a direction opposite to the forward direction is referred to as a “rearward direction”.

The outer periphery of a rear portion of the tube coupling 21 is formed so as to have a slightly small diameter after being slightly bulged in the forward direction (which may be simply bulged, or may be formed in a so-called telescoping shape). The tube T and the tube coupling 21 are connected as follows. The tube T is forcibly inserted onto the tube coupling 21, and then an annular body 24 that is inserted onto the tube T is forcibly moved onto a bulging portion of the tube T. An insertion state of the tube T onto the tube coupling 21 can be visually observed, and thus the tube T can be properly inserted onto and held by the tube coupling 21.

The annular body 24 prevents the tube T from coming out of the tube coupling 21 by bringing the tube T into close contact with the rear portion of the tube coupling 21, but the annular body 24 may be omitted if an attachment force between the rear portion of the tube coupling 21 and the tube T is strong enough so that no problems arise during use.

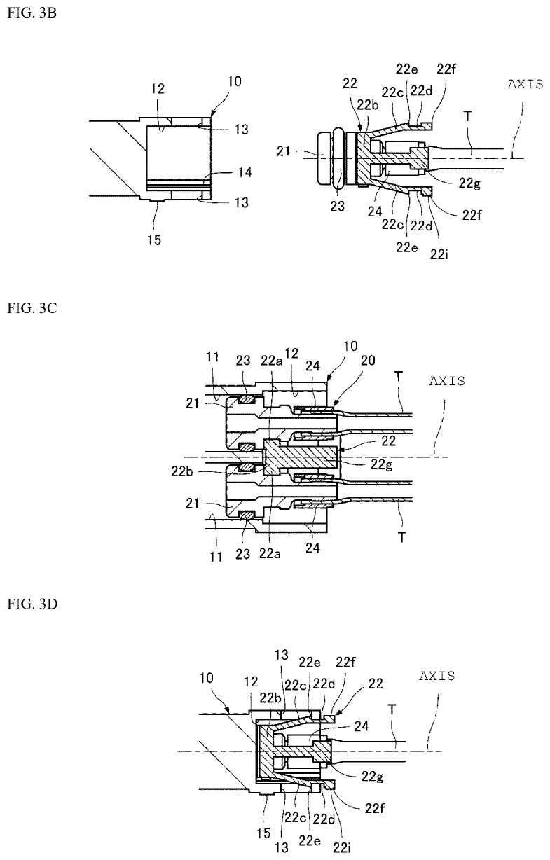

FIG. 4 is a perspective view of the male member 20 illustrated in FIG. 1A, illustrating a state in which the tube couplings 21 are removed from the retainer 22. As illustrated in FIG. 4, the retainer 22 has two receiving portions 22a into which the tube couplings 21 are fitted, a linking portion 22b which links the plurality of receiving portions 22a, and rod-shaped portions 22c extending from the linking portion 22b. An intermediate portion of the tube coupling 21 in a front-rear direction is fitted into the receiving portion 22a.

As illustrated in FIGS. 3B and 3D, the rod-shaped portions 22c each extend from the linking portion 22b at an angle such that a diameter expands with respect to the axis of the male member 20. A portion of each of the rod-shaped portions 22c extends parallel to the axis of the male member 20, and an engaging claw 22e is formed by a recess 22d provided in the portion of each of the rod-shaped portions 22c. In the state in which the male member 20 is inserted into the female member 10, the engaging claws 22e enter the engaging holes 13 of the female member 10, and the engaging claws 22e engage with the engaging holes 13. Accordingly, the female member 10 and the male member 20 are prevented from coming off.

The rod-shaped portions 22c each are provided with an operation portion 22f on a free end side. When the operation portions 22f are pinched with fingers and the rod-shaped portions 22c are pressed toward the axis of the male member 20, the rod-shaped portions 22c are elastically deformed with base ends thereof on sides opposite to the free ends as fixed ends. Accordingly, the engagement between the engaging holes 13 of the female member 10 and the engaging claws 22e of the rod-shaped portions 22c is released, and the male member 20 can be pulled out from the female member 10.

In the pipe coupling 100, the two tubes T are connected to the female member 10 by only inserting the male member 20 into the female member 10. In addition, the two tube couplings 21 are held by the single retainer 22, and thus external dimensions of the male member 20 can be reduced. Therefore, the number of work hours can be reduced and workability in a narrow work space can be improved in a connection work for the tubes T.

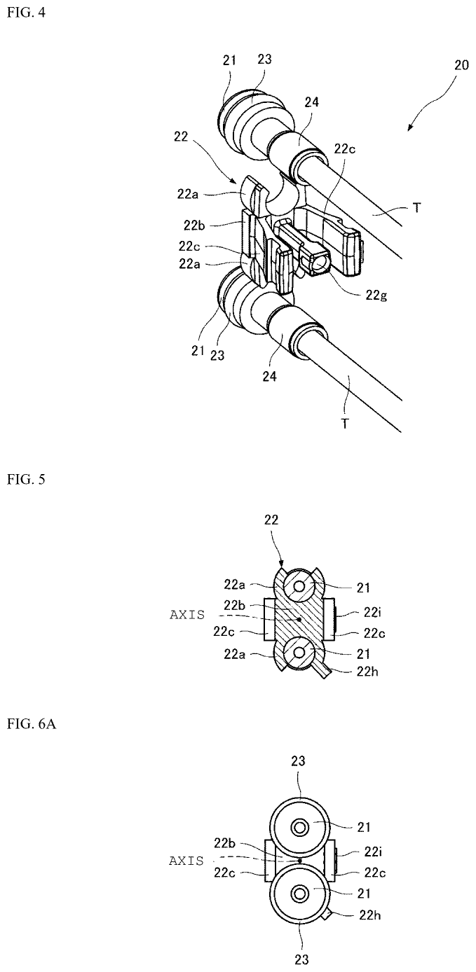

FIG. 5 is a cross-sectional view taken along line V-V illustrated in FIG. 2A. As illustrated in FIGS. 4 and 5, the two receiving portions 22a are arranged with the axis of the male member 20 interposed therebetween. The receiving portions 22a each have a C-shaped cross section. Therefore, the tube couplings 21 can be fitted into and pulled out from the receiving portions 22a through openings of the respective C-shaped cross sections. Therefore, the tube couplings 21 can be easily attached to and detached from the retainer 22.

When the two tube couplings 21 are attached to the retainer 22, it is difficult to attach the tubes T to the tube couplings 21. The tube couplings 21 are attached to and detached from the retainer 22, and thus the tube couplings 21 can be attached to the retainer 22 after the tubes T are attached to the tube couplings 21. Therefore, a work of connecting the plurality of tubes T to the female member 10 can be further facilitated.

The openings of the C-shaped cross sections of the two receiving portions 22a are directed opposite to each other by 180°, that is, to sides opposite to the axis of the male member 20, in consideration of the attachment and detachment of the tube couplings 21. An arm portion of the C-shaped cross section is set such that a deflection amount of the arm portion becomes uniform when attaching and detaching the tube coupling 21. An opening width of the C-shaped cross section is set such that the arm portion of the C-shaped cross section does not crack at the time of attaching and detaching the tube coupling 21, and the tube coupling 21 does not come off the receiving portion 22a when being handled.

As illustrated in FIGS. 3B and 3D, the retainer 22 has a stopper 22g extending along the axis of the male member 20 from the linking portion 22b. The stopper 22g restricts the deformation of the rod-shaped portions 22c. Therefore, the rod-shaped portions 22c can be prevented from being excessively deformed when the rod-shaped portions 22c are pressed, and the rod-shaped portions 22c can be prevented from being damaged.

As illustrated in FIG. 5, one of the two receiving portions 22a is provided with a protrusion 22h that protrudes outward. The protrusion 22h is not provided on the other of the two receiving portions 22a.

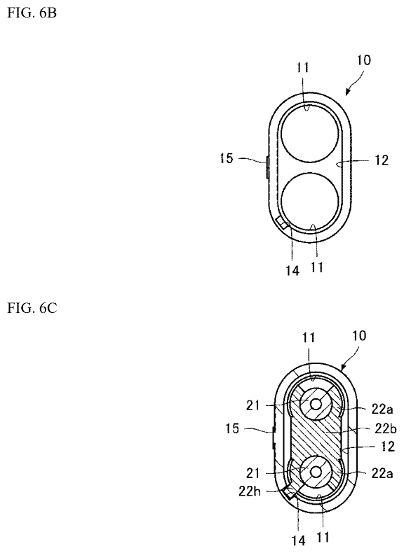

FIG. 6A is a side view of the male member 20 illustrated in FIG. 2A as viewed in a direction of an arrow VIA. As illustrated in FIG. 6A, the protrusion 22h protrudes outward from the tube coupling 21 when the male member 20 is viewed along the axis of the male member 20. That is, an outer surface shape of the male member 20 is asymmetrically formed due to the protrusion 22h.

FIG. 6B is a side view of the female member 10 illustrated in FIG. 2A as viewed in a direction of an arrow VIB. FIG. 6C is a cross-sectional view taken along line VIC-VIC illustrated in FIG. 2D. As illustrated in FIGS. 6B and 6C, the female member 10 is formed with only one groove 14 capable of receiving the protrusion 22h. Therefore, the male member 20 can be inserted into the female member 10 in a state in which positions of the protrusion 22h and the groove 14 are aligned with each other around the axis of the male member 20, but the protrusion 22h interferes with the female member 10, and the male member 20 cannot be inserted into the female member 10 in a state in which the positions of the protrusion 22h and the groove 14 are not aligned with each other around the axis of the male member 20. Therefore, the male member 20 can be prevented from being inserted into the female member 10 in an unintended orientation. Therefore, the two tubes T can be reliably connected to the intended small-diameter hole portions 11 of the female member 10.

As illustrated in FIGS. 5 and 6C, the protrusion 22h extends outward from an opening end of the C-shaped cross section of the receiving portion 22a. Therefore, the protrusion 22h does not affect a diameter-increasing operation of the arm portion of the C-shaped cross section. Therefore, the tube couplings 21 can be easily attached to and detached from the receiving portions 22a.

As illustrated in FIGS. 2A to 2D, the female member 10 is provided with one identification mark 15, and the operation portion 22f of the retainer 22 is provided with one identification mark 22i. The identification mark 15 and the identification mark 22i are directed in the same direction in the state in which the positions of the protrusion 22h and the groove 14 are aligned with each other around the axis of the male member 20. Therefore, it is possible to visually confirm whether the male member 20 is directed in an intended direction with respect to the female member 10. Therefore, the two tubes T can be more reliably connected to the intended small-diameter hole portions 11 of the female member 10.

In the present embodiment, the identification mark 15 and the identification mark 22i are triangular marks formed to be bulged on an outer peripheral surface of the female member 10 and the operation portions 22f of the retainer 22, but the present invention is not limited to this form.

In the pipe coupling 100, the tubes T can be connected in the following order.

First, the tube T is forcibly inserted onto the tube coupling 21, and then the annular body 24 that is inserted onto the tube T is forcibly moved onto the bulging portion of the tube T. The other tube coupling 21 and the other tube T are connected in the same manner. Next, the two tube couplings 21 are fitted into the receiving portions 22a of the retainer 22 to form the male member 20. Next, the positions of the protrusion 22h and the groove 14 are aligned with each other around the axis of the male member 20, and the male member 20 is inserted into the female member 10. When the male member 20 is inserted into the female member 10 until the engaging claws 22e reach the engaging holes 13, the small-diameter hole portions 11 and the tube couplings 21 are in a fluid-tight state by the seal rings 23. In addition, the engaging claws 22e of the rod-shaped portions 22c and the engaging holes 13 of the female member 10 engage with each other, and are prevented from coming off.

In the pipe coupling 100, the tubes T can be separated in the following order.

First, the operation portions 22f of the rod-shaped portions 22c are pinched with fingers and pressed toward the axis of the male member 20. Accordingly, the engagement between the engaging claws 22e of the rod-shaped portions 22c and the engaging holes 13 of the female member 10 is released. In this state, when the male member 20 is pulled out from the female member 10, the male member 20 is separated from the female member 10. The tube couplings 21 and the tubes T can be separated by removing the tube couplings 21 from the retainer 22 of the male member 20.

### Second Embodiment

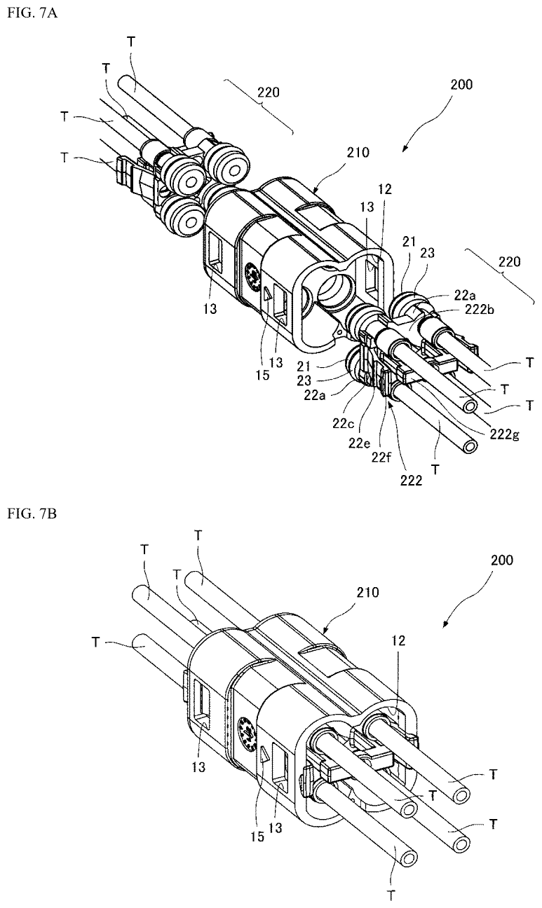

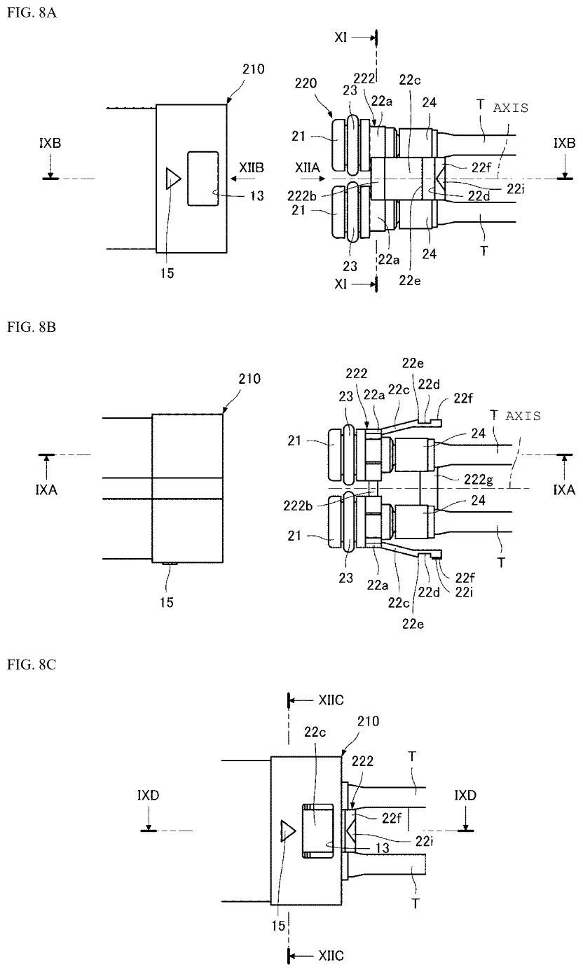

FIG. 7A is a perspective view of a pipe coupling 200 according to a second embodiment, illustrating a state before a female member 210 and male members 220 are connected. FIG. 7B is a perspective view of the pipe coupling 200 according to the second embodiment, illustrating a state in which the female member 210 and the male members 220 are connected. FIG. 8A is a front view of the pipe coupling 200 according to the second embodiment, illustrating the state before the female member 210 and the male member 220 are connected. FIG. 8B is a top view of the pipe coupling 200 according to the second embodiment, illustrating the state before the female member 210 and the male member 220 are connected. FIG. 8C is a front view of the pipe coupling 200 according to the second embodiment, illustrating the state in which the female member 210 and the male member 220 are connected. FIG. 8D is a top view of the pipe coupling 200 according to the second embodiment, illustrating the state in which the female member 210 and the male member 220 are connected.

Hereinafter, differences from the first embodiment will be mainly described, and the same reference numerals as those in the first embodiment are given to the same or corresponding configurations as those in the first embodiment in the drawings, and description thereof will be omitted. FIGS. 7A and 7B illustrate an example in which two male members 220 are inserted into one female member 210 from both sides, but the present invention is not limited to this form.

In the present embodiment, the female member 210 has four small-diameter hole portions 11. Central axes of the four small-diameter hole portions 11 are approximately parallel to an insertion direction of the male members 220, and the four small-diameter hole portions 11 are arranged in an annular shape. A retainer 222 holds the four tube couplings 21 such that the four tube couplings 21 are arranged in an annular shape around a predetermined axis extending parallel to the insertion direction of the male members 220.

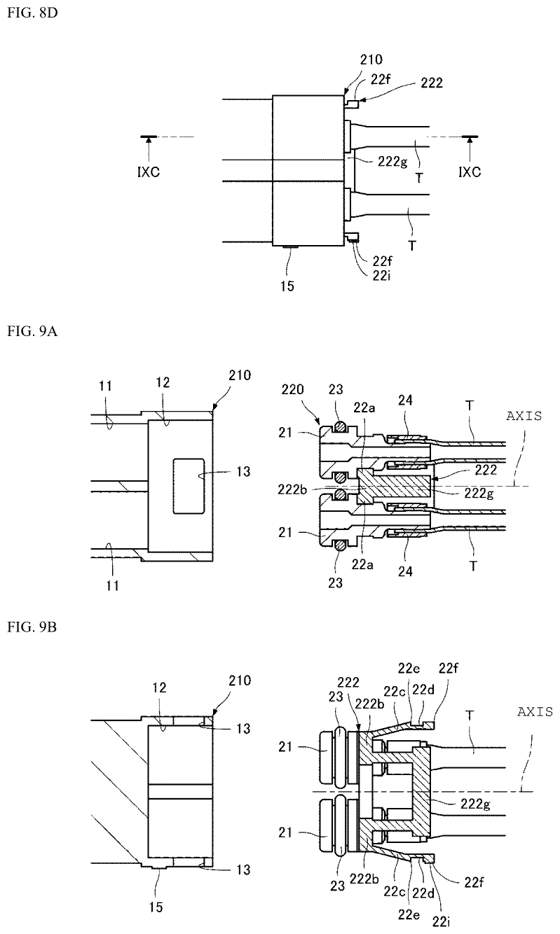

FIG. 9A is a cross-sectional view taken along line IXA-IXA illustrated in FIG. 8B. FIG. 9B is a cross-sectional view taken along line IXB-IXB illustrated in FIG. 8A. FIG. 9C is a cross-sectional view taken along line IXC-IXC illustrated in FIG. 8D. FIG. 9D is a cross-sectional view taken along line IXD-IXD illustrated in FIG. 8C.

As illustrated in FIGS. 9A to 9D, in a state in which the male member 220 is inserted into the female member 210, the tube couplings 21 are inserted into the corresponding small-diameter hole portions 11 of the female member 210. The seal ring 23 seals between the outer peripheral surface of the tube coupling 21 and the inner peripheral surface of the small-diameter hole portion 11. The seal rings 23 can ensure fluid tightness between the male member 220 and the female member 210.

In the present embodiment, the predetermined axis serving as a center of the arrangement of the four tube couplings 21 is referred to as an “axis of the male member 220”.

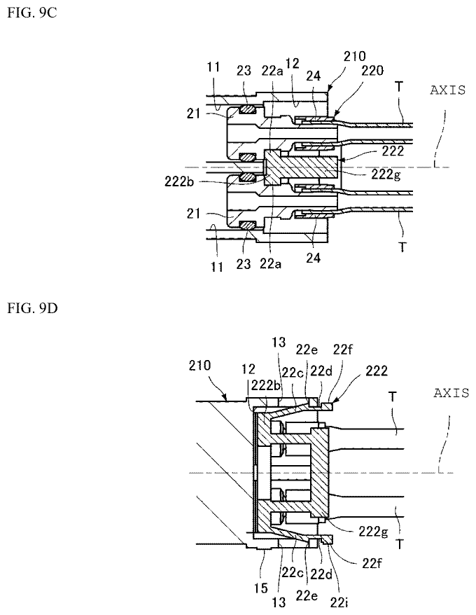

FIG. 10 is a perspective view of the male member 220 illustrated in FIG. 7A, illustrating a state in which the tube couplings 21 are removed from the retainer 222. As illustrated in FIG. 10, the retainer 222 has four receiving portions 22a into which the tube couplings 21 are fitted, a linking portion 222b which links the four receiving portions 22a, and rod-shaped portions 22c extending from the linking portion 222b.

As illustrated in FIGS. 9B and 9D, in the state in which the male member 220 is inserted into the female member 210, the engaging claws 22e enter the engaging holes 13 of the female member 210, and the engaging claws 22e engage with the engaging holes 13. Accordingly, the female member 210 and the male member 220 are prevented from coming off.

When the operation portions 22f are pinched with fingers and the rod-shaped portions 22c are pressed toward the axis of the male member 220, the rod-shaped portions 22c are elastically deformed with base ends thereof on sides opposite to the free ends as fixed ends. Accordingly, the engagement between the engaging holes 13 of the female member 210 and the engaging claws 22e of the rod-shaped portions 22c is released, and the male member 220 can be pulled out from the female member 210.

In the pipe coupling 200, the four tubes T are connected to the female member 210 by only inserting the male member 220 into the female member 210. In addition, the four tube couplings 21 are held by the single retainer 222, and thus external dimensions of the male member 220 can be further reduced. Therefore, the number of work hours can be reduced and workability in a narrow work space can be further improved in a connection work for the tubes T.

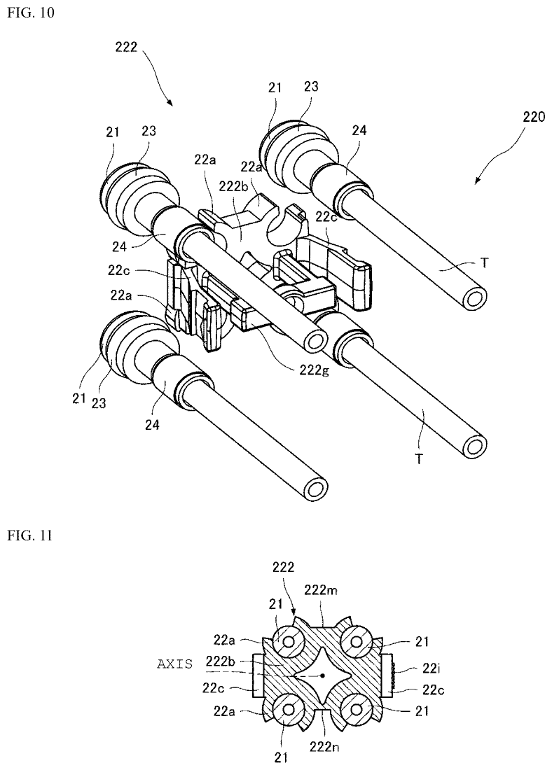

FIG. 11 is a cross-sectional view taken along line XI-XI illustrated in FIG. 8A. As illustrated in FIG. 11, the four receiving portions 22a are arranged in an annular shape around the axis of the male member 220. The openings of the C-shaped cross sections are directed to a side opposite to the axis of the male member 220, that is, outward in a radial direction about the axis of the male member 220 in consideration of the attachment and detachment of the tube couplings 21.

As illustrated in FIGS. 9B and 9D, the retainer 222 has a stopper 222g extending along the axis of the male member 220 from the linking portion 222b. The stopper 222g restricts the deformation of the rod-shaped portions 22c. Therefore, the rod-shaped portions 22c can be prevented from being excessively deformed when the rod-shaped portions 22c are pressed, and the rod-shaped portions 22c can be prevented from being damaged.

As illustrated in FIG. 11, the linking portion 222b is asymmetrical by portions at 90° from the rod-shaped portions 22 c in both directions around the axis of the male member 220. Specifically, the linking portion 222b includes an upper surface 222m located on an upper side in FIG. 11 and a lower surface 222n located on a lower side in FIG. 11, and the upper surface 222m is farther away from the axis than the lower surface 222n.

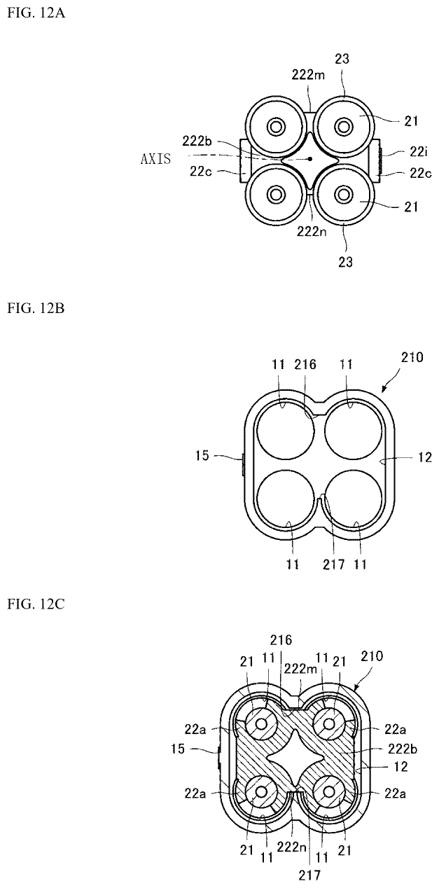

FIG. 12A is a side view of the male member 220 illustrated in FIG. 8A as viewed in a direction of an arrow XIIA. As illustrated in FIG. 12A, the upper surface 222m and the lower surface 222n of the linking portion 222b are not covered by the tube couplings 21 and are exposed when the male member 220 is viewed along the axis of the male member 220. That is, an outer surface shape of the male member 220 is asymmetrically formed by the upper surface 222m and the lower surface 222n of the linking portion 222b.

FIG. 12B is a side view of the female member 210 illustrated in FIG. 8A as viewed in a direction of an arrow XIIB. FIG. 12C is a cross-sectional view taken along line XIIC-XIIC illustrated in FIG. 8C. As illustrated in FIGS. 12B and 12C, the female member 210 is formed with protruding portions 216 and 217 protruding toward the center of the common hole portion 12. The protruding portions 216 and 217 are arranged with the center of the common hole portion 12 interposed therebetween.

A tip of the protruding portion 216 is farther away from the center of the common hole portion 12 than a tip t of the protruding portion 217. Therefore, the male member 220 can be inserted into the female member 210 in a state in which positions of the upper surface 222m of the linking portion 222b and the protruding portion 216 of the female member 210 are aligned with each other and positions of the lower surface 222n of the linking portion 222b and the protruding portion 217 of the female member 210 are aligned with each other around the axis of the male member 220. On the other hand, the protruding portion 217 of the female member 210 interferes with the linking portion 222b of the male member 220 and the male member 220 cannot be inserted into the female member 210 in a state in which the positions of the upper surface 222m of the linking portion 222b and the protruding portion 216 of the female member 210 are not aligned with each other and the positions of the lower surface 222n of the linking portion 222b and the protruding portion 217 of the female member 210 are not aligned with each other around the axis of the male member 220. Therefore, the male member 220 can be prevented from being inserted into the female member 210 in an unintended orientation. Therefore, the four tubes T can be reliably connected to the intended small-diameter hole portions 11 of the female member 210.

The upper surface 222m and the lower surface 222n of the linking portion 222b, which make the outer surface shape of the male member 220 asymmetric are portions that are at 90° from the rod-shaped portions 22c in both directions around the axis of the male member 220 and that do not affect the elastic deformation of the rod-shaped portions 22c. Therefore, a fitting strength between the female member 210 and the male member 220 is not affected, and the female member 210 and the male member 220 can be easily joined and separated.

In the pipe coupling 200, the tubes T can be connected in the following order.

First, the tube T is forcibly inserted onto the tube coupling 21, and then the annular body 24 that is inserted onto the tube T is forcibly moved onto a bulging portion of the tube T. The other three tube couplings 21 and the other three tubes T are connected in the same manner. Next, the four tube couplings 21 are fitted into the receiving portions 22a of the retainer 222 to form the male member 220. Next, the positions of the upper surface 222m of the linking portion 222b and the protruding portion 216 of the female member 210 are aligned with each other and the positions of the lower surface 222n of the linking portion 222b and the protruding portion 217 of the female member 210 are aligned with each other around the axis of the male member 220, and the male member 220 is inserted into the female member 210. When the male member 220 is inserted into the female member 210 until the engaging claws 22e reach the engaging holes 13, the small-diameter hole portions 11 and the tube couplings 21 are in a fluid-tight state by the seal rings 23. In addition, the engaging claws 22e of the rod-shaped portions 22c and the engaging holes 13 of the female member 210 engage with each other, and are prevented from coming off.

In the pipe coupling 200, the tubes T can be separated in the following order.

First, the operation portions 22f of the rod-shaped portions 22c are pinched with fingers and pressed toward the axis of the male member 220. Accordingly, the engagement between the engaging claws 22e of the rod-shaped portions 22c and the engaging holes 13 of the female member 210 is released. In this state, when the male member 220 is pulled out from the female member 210, the male member 220 is separated from the female member 210. The tube couplings 21 and the tubes T can be separated by removing the tube couplings 21 from the retainer 222 of the male member 220.

Although the embodiments and modifications of the present invention have been described above, the present invention is not limited to the above-described embodiments and modifications, and can be appropriately modified within the scope of the gist of the present invention.

In the first embodiment, there are two tube couplings 21, and in the second embodiment, there are four tube couplings 21, but there may be three tube couplings 21 or five or more tube couplings 21.

In the first and second embodiments, the engaging claws 22e of the rod-shaped portions 22c engage with the engaging holes 13 of the female member 10, 210, but the present invention is not limited to this form, and it is sufficient that the rod-shaped portions 22c engage with the wall surface of the female member 10, 210 to prevent the female member 10, 210 and the male member 20, 220 from coming off.

In the first embodiment, the outer surface shape of the male member 20 is asymmetrically formed due to the protrusion 22h, and in the second embodiment, the outer surface shape of the male member 220 is asymmetrically formed due to the upper surface 222m and the lower surface 222n, but the present invention is not limited to these forms. The male member 20, 220 has an asymmetric outer surface shape, and the female member 10, 210 can receive the male member 20, 220 in a state being directed in a predetermined direction around the axis of the male member 20, 220, but may not receive the male member 20, 220 in a state being directed in a direction different from the predetermined direction around the axis of the male member 20, 220.

### REFERENCE SIGN LIST

100, 200 pipe coupling
10, 210 female member
20, 220 male member
21 tube coupling
22, 222 retainer
22a receiving portion
22b, 222b linking portion
22c rod-shaped portion
T tube

1. A pipe coupling comprising:
a female member; and a male member to be inserted into the female member, wherein
the male member includes
a plurality of tube couplings to which tubes are attachable, and
a retainer that holds the plurality of tube couplings,
the retainer includes
a plurality of receiving portions into which the tube couplings are fitted,
a linking portion that links the plurality of receiving portions, and
a rod-shaped portion extending from the linking portion at an angle such that a diameter expands with respect to an axis of the male member, and
the rod-shaped portion engages with a wall surface of the female member in a state in which the male member is inserted into the female member to prevent the female member and the male member from coming off, and when the rod-shaped portion is pressed, the rod-shaped portion is elastically deformed with a base end thereof as a fixed end to release the engagement with the wall surface of the female member.

2. The pipe coupling according to claim 1, wherein
a portion of the rod-shaped portion extends parallel to the axis of the male member, and an engaging claw is formed by a recess provided in the portion of the rod-shaped portion, and the engaging claw engages with the wall surface of the female member.

3. The pipe coupling according to claim 1, further comprising:
a plurality of the tubes respectively attached to the plurality of tube couplings.

4. The pipe coupling according to claim 1, wherein
the receiving portions are formed such that the plurality of tube couplings are able to be attached to and detached from the receiving portions.

5. The pipe coupling according to claim 1, wherein
the receiving portions each have a C-shaped cross section.

6. The pipe coupling according to claim 5, wherein
the retainer has two of the receiving portions,
the two receiving portions are arranged with the axis of the male member interposed therebetween, and
an opening of the C-shaped cross section is directed to a side opposite to the axis of the male member.

7. The pipe coupling according to claim 5, wherein
the retainer has four of the receiving portions,
the four receiving portions are arranged in an annular shape around the axis of the male member, and
an opening of o the C-shaped cross section is directed outward in a radial direction about the axis of the male member.

8. The pipe coupling according to claim 1, wherein
the retainer further includes a stopper that is provided in the linking portion and restricts the deformation of the rod-shaped portion.

9. The pipe coupling according to claim 1, wherein
the male member has an asymmetric outer surface shape, and
the female member is configured to receive the male member in a state of being directed in a predetermined direction around the axis of the male member, and not to receive the male member in a state of being directed in a direction different from the predetermined direction around the axis of the male member.

10. The pipe coupling according to claim 9, wherein
the plurality of receiving portions each have a C-shaped cross section, and
the outer surface shape of the male member is asymmetrically formed due to a protrusion extending outward from an opening end of the C-shaped cross section of one of the receiving portions.

11. The pipe coupling according to claim 9, wherein
the male member is asymmetrical by portions at 90° from the rod-shaped portion in both directions around the axis of the male member.
